(19) United States
(12) Patent Application Publication
(10) Pub. No.: US 2008/0054528 A1
(43) Pub. Date: Mar. 6, 2008

(54) MATERIAL-FEEDING STRUCTURE FOR A MOLD AND CASING FABRICATION METHOD USING THE SAME STRUCTURE

(76) Inventor: Chien-Tsai CHUEH, Hsinchu (TW)

Correspondence Address: SINORICA, LLC, 528 FALLSGROVE DRIVE, ROCKVILLE, MD, 20850, US

(21) Appl. No.: 11/768,212

(22) Filed: Jun. 26, 2007

(30) Foreign Application Priority Data
Sep. 5, 2006 (TW) 095132705

(51) Int. Cl. B29C 45/27

(52) U.S. Cl. 264/328.12; 425/573

(57) ABSTRACT

The present invention discloses a material-feeding structure for a mold and a casing fabrication method using the same structure. The material-feeding structure for a mold of the present invention comprises: a mold, at least one runner and a channel. The runner is disposed in the mold and has an gate at a narrower face of the runner, and the channel is connected to the gate of the runner. After molten plastic has been injected into the channel, the molten plastic moves through the channel and enters the runner via the corresponding gate to occur the reflux of the molten plastic inside the runner, whereby the colder molten plastic deposits on the bottom of the runner, and the hotter molten plastic continues to flow into the mold. After the mold is filled with the molten plastic, the molten plastic inside the mold is cooled and solidified to form a casing. Thereby, the material-feeding structure for a mold and the casing fabrication method using the same structure of the present invention can prevent dark stains and white spots from forming on the appearance of products.

### BACKGROUND OF THE INVENTION

1. Field of the Invention

The present invention relates to a material-feeding structure for a mold and a casing fabrication method using the same structure, particularly to a material-feeding structure for a mold and a casing fabrication method using the same structure to prevent dark stains and white spots from forming on the appearance of a product.

2. Description of the Related Art

In an injection molding process, solid plastic raw material is melted into a liquid state, and the molten plastic is injected into the cavity of a mold. After the mold cavity is filled with the molten plastic, the molten plastic is cooled into a solid state. Then, the mold is split, and the product is ejected from the mold. In the conventional injection molding technology, the runner via which molten plastic enters the mold cavity has great influence on the molding process and the internal stress of the product.

Refer to FIG. 1 a diagram schematically showing a conventional material-feeding structure for an injection mold. In FIG. 1, the injection mold 2 has a runner 4, which is a rectangular solid. The runner 4 has an gate 8 on a wider rectangular face 6 thereof. The gate 8 is connected with a sprue 10 for transporting the molten plastic. In an injection molding process, the molten plastic moves through the sprue 10 and enters the runner 4 via the gate 8 and then flows into the injection mold 2. However, such a method hass a great molding pressure. Therefore, the mold is apt to deform, and the dimensions of products are hard to control. As the runner 4 is colder than molten plastic, the molten plastic contacting the surface of the cavity of the runner 4 is chilled and becomes the so-called cold material, which forms dark stains and white spots on the appearance of products. As shown in FIG. 2, there is a dark stain 14 forming on the corresponding surface of the produced panel casing 12. Therefore, the products requiring fine appearance further need an extra surface-processing step to remove those dark stains and white spots. Thus, the fabrication cost increases.

Accordingly, the present invention proposes a material-feeding structure for a mold and a casing fabrication method using the same structure to solve the abovementioned problems.

### SUMMARY OF THE INVENTION

One objective according to an embodiment of the present invention is to provide a material-feeding structure for a mold and a casing fabrication method using the same structure to prevent dark stains and white spots from forming on the appearance of products.

Another objective of the present invention is to provide a material-feeding structure for a mold and a casing fabrication method using the same structure to reduce molding pressure, prolong the service life of molds and make the dimensions of products is easy to control.

According to one aspect, a material-feeding structure for a mold of the present invention comprises a mold, at least one runner and a sprue. The runner is formed in the mold and has a rectangular parallelepiped shape which includes a pair of first faces and a pair of second faces. A width of the first face is smaller than a width of the second face. A gate is formed on one first face, which is narrower than the second face, and the sprue is connected to the gate of each runner. When the material-feeding structure of the present invention is used in fabricating a product, such as a casing, molten plastic material moves through the sprue and enters the runners respectively via their gates and then flows into the mold. As the gate is formed on the narrower first face, the runner has enough space to allow the reflux of the molten plastic material inside the runner. Thus, the colder molten plastic material deposits on the bottom of the runner, and the hotter molten plastic material continues to flow into the mold. After the mold is filled with the molten plastic material, the mold is cooled to solidify the molten plastic. Then, the mold is split, and the casing is ejected.

Other objectives, features and advantages of the present invention will be further understood from the further technology features disclosed by the embodiments of the present invention wherein there are shown and described preferred embodiments of this invention, simply by way of illustration of modes best suited to carry out the invention

### BRIEF DESCRIPTION OF THE DRAWINGS

FIG. 1 is a diagram schematically showing a conventional material-feeding structure for an injection mold;

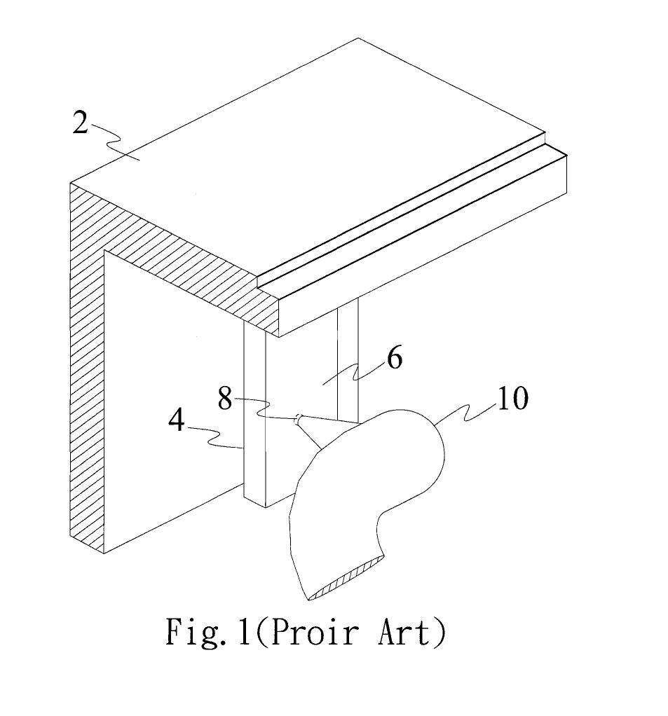

FIG. 2 is a diagram schematically showing a panel casing fabricated by the conventional injection molding technology;

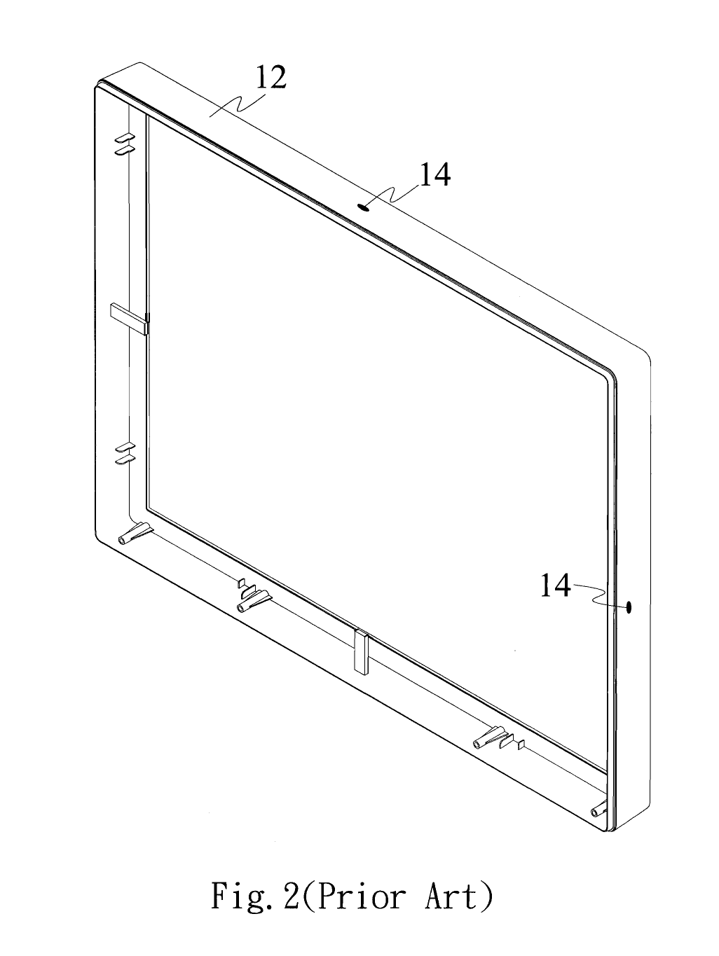

FIG. 3 is a stereogram view schematically showing the material-feeding structure for a mold according to an embodiment of the present invention; and

FIG. 4 is a diagram schematically showing a panel casing fabricated according to an embodiment of the present invention.

### DETAILED DESCRIPTION OF THE INVENTION

It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present invention pertains to a material-feeding structure for a mold and a casing fabrication method using the same structure to prevent dark stains and white spots from forming on the appearance of a product. The present invention is applied to injection molding processes for fabricating various casings. Below, a mold of fabricating a panel casing is used in the exemplification of the present invention.

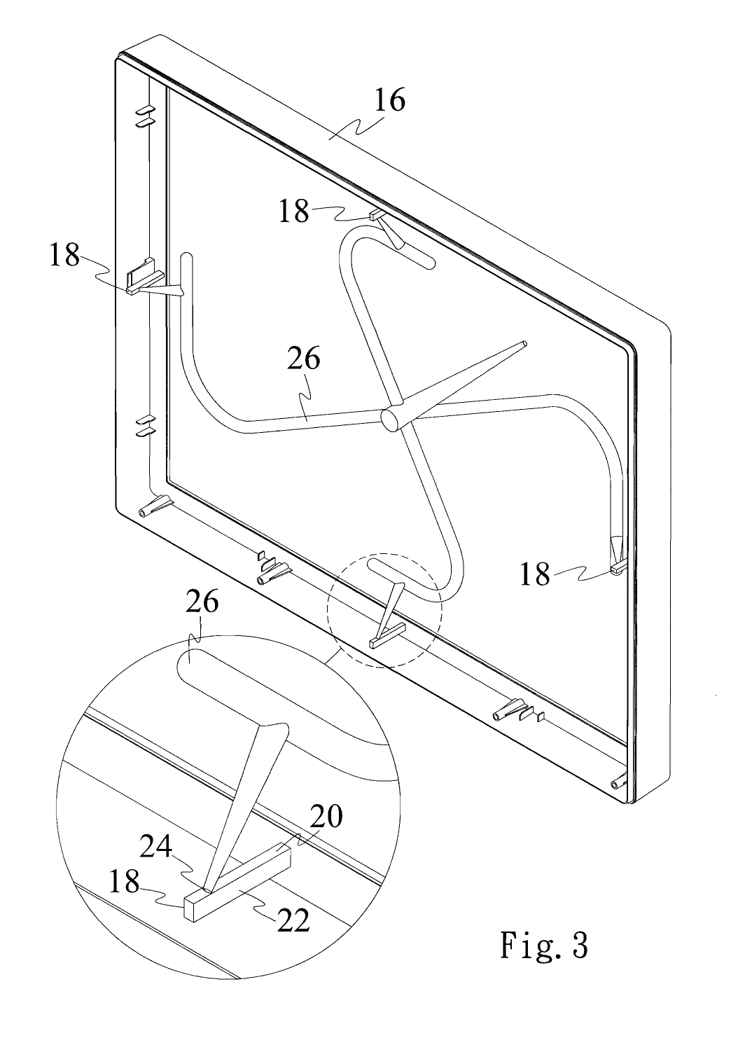

Refer to FIG. 3 a stereogram view schematically showing the material-feeding structure for a mold according to an embodiment of the present invention. As shown in FIG. 3, in this embodiment, the material-feeding structure for a mold comprises a mold 16 of fabricating a panel casing, four runners 18, and a sprue 26. Four runners 18 are respectively arranged on four sides of the mold 16; each runner 18 has a rectangular-parallelepiped shape which includes a pair of first faces 20 and a pair of second faces 22. The pair of the second faces 22 are connected between the pair of the first faces 20. A length of the first face 20 is equal to a length of the second face 22, and a width of the first face 20 is smaller than a width of the second face 22. An gate 24 is formed on the narrower first face 20 of each runner 18. The sprue 26 is connected to the gate 24 of each runner 18. In an injection molding process, molten plastic material moves through the sprue 26 and enters each runner 18 via the corresponding gate 24 for flowing into the mold 16. The plastic material is an Acrylonitrile-Butadiene-Styrene (ABS) resin or a mixture of ABS and PolyCarbonate (PC), for example.

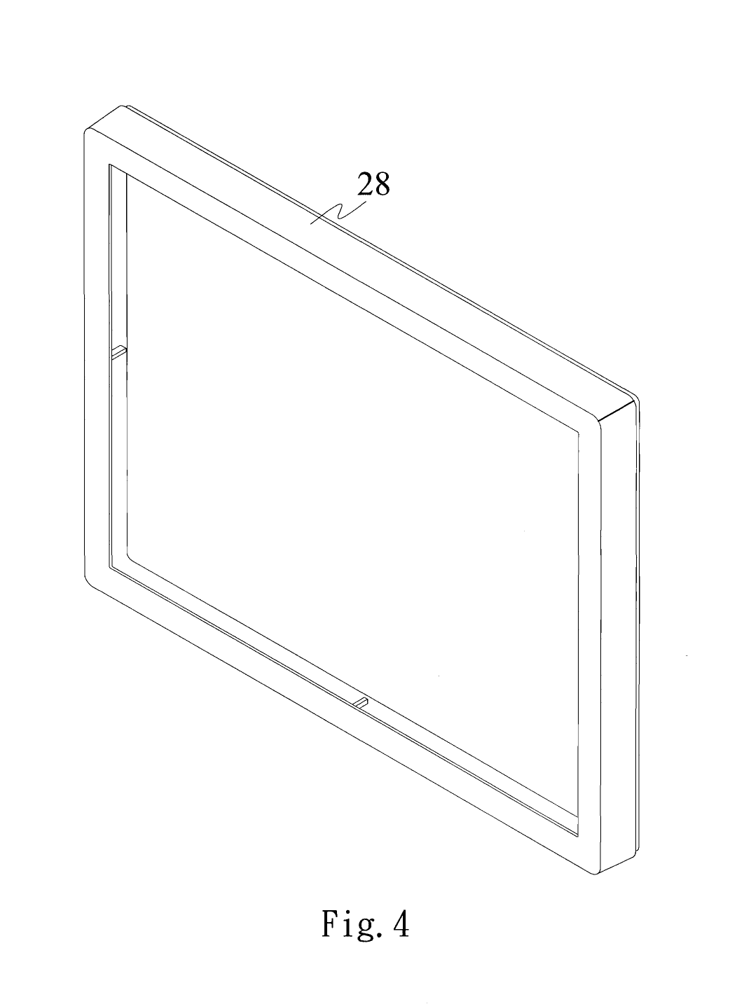

Below, a casing fabrication method using the abovementioned material-feeding structure for a mold is to be described. Firstly, a mold 16 is provided. Next, molten plastic material is injected into the sprue 26, and the molten plastic material moves through the sprue 26 and enters each runner 18 via the corresponding gate 24 on the runner 18. Because the molten plastic material enters the runner 18 via the gate 24 formed on the narrower first face 20, there is enough space to occur the reflux of the molten plastic material inside the runner 18. Thus, the colder of the molten plastic material deposits on the bottom of the runner 18, and the hotter of molten plastic material continues to flow into the mold 16. After the mold 16 is filled with the molten plastic material, the molten plastic in the mold 16 is cooled down to a temperature at which the plastic material is solidified to have enough strength, and then the plastic material is solidified into a panel casing 28. Then, the mold 16 is split, and the panel casing 28 is ejected, as shown in FIG. 4.

Therefore, the present invention reduces molding pressure, prolong the service life of molds and make the dimensions of products is easy to control. Further, because the colder molten plastic deposits on the bottom of the runner, the present invention prevents dark stains and white spots from forming on the appearance of products. Thereby, the succeeding surface-processing step used in the conventional technology to remove dark stains and white spots is omitted in the present invention. Thus, the fabrication cost decreases.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A material-feeding structure, comprising:
a mold;
at least one runner formed in said mold and having a rectangular parallelepiped shape which includes a pair of first faces and a pair of second faces, wherein said pair of second faces are connected between said pair of first faces, a length of each of said first faces is equal to a length of each of said second faces, a width of each of said first faces is smaller than a width of each of said second faces, and an gate is formed on one of said first faces; and
a sprue connected to said gate of said at least one runner, wherein plastic material moves through said sprue and enters each said runner via said gate for flowing into said mold.

2. The material-feeding structure according to claim 1, wherein said plastic material is an Acrylonitrile-Butadiene-Styrene (ABS) resin or a mixture of ABS and PolyCarbonate (PC).

3. The material-feeding structure according to claim 1, wherein said mold is used to fabricate a panel casing.

4. The material-feeding structure according to claim 1, further comprising a plurality of runners; said plurality of runners are arranged in different positions of said mold, and said sprue is connected to said gate of each of said plurality of runners; thereby, said plastic material moves through said sprue and enters said plurality of runners respectively via the corresponding said gates for flowing into said mold.

5. A casing fabrication method using the material-feeding structure according to claim 1, said method comprising the following steps:
providing said mold;
injecting plastic material into said sprue;
letting said plastic material move through said sprue and enter said at least one runner via said gate formed on said runner to occur a reflux of said plastic material inside said at least one runner, and making a colder of said plastic material deposit on a bottom of said at least one runner and a hotter of said plastic material continue to flow into said mold; and
after said mold is filled with said plastic material, cooling and solidifying said plastic material inside said mold to form a casing.

6. The method according to claim 5, wherein said plastic material is an Acrylonitrile-Butadiene-Styrene (ABS) resin or a mixture of ABS and PolyCarbonate (PC).

7. The method according to claim 5, wherein said casing is a panel casing.

8. The method according to claim 5, further comprising a step of splitting said mold and ejecting said casing after said plastic material of said mold is solidified into said casing.
